(19) United States
(12) Patent Application Publication
(10) Pub. No.: US 2011/0213626 A1
(43) Pub. Date: Sep. 1, 2011

(54) SYSTEM AND METHOD FOR EFFICIENT CLAIM ASSIGNMENT

(76) Inventors: Patricia Ann Brewer, Bristol, CT (US); Murugan Govindan, Farmington, CT (US); Anne K. Haas, Warrenville, IL (US); Carol A. Hartmann, East Hampton, CT (US); Molly C. Hayward, West Hartford, CT (US); James Sun-Ming Lee, West Hartford, CT (US); Jennifer Murphy-Smith, Bloomfield, CT (US); Vasan S.S. Papanasam, Glastonbury, CT (US); Haritha Vadavalli, South Windsor, CT (US); Kenneth W. Williams, Windsor, CT (US)

(21) Appl. No.: 12/715,032

(22) Filed: Mar. 1, 2010

(51) Int. Cl. G06Q 40/00

(52) U.S. Cl. 705/4

(57) ABSTRACT

A system includes a data storage device configured to receive and store policy information associated with an insurance policy, and a first data structure associating each of a plurality of program identifiers with a respective claim handling identifier, a computer processor configured to execute program instructions and retrieve the policy information from the data storage device, and a memory, coupled to the computer processor, configured to store program instructions for execution by the computer processor.

Also included is claim assignment logic comprising program instructions stored in the memory and executable by the computer processor to determine a program identifier based on the policy information and to determine a first claim handling identifier associated with the program identifier in the first data structure. If the first claim handling identifier is a first predetermined claim handling identifier, a record associating the policy information with the first claim handling identifier is generated. If the first claim handling identifier is a second predetermined claim handling identifier, a second claim handling identifier is determined based on the policy information, and a record associating the policy information with the second claim handling identifier is generated. A communication device is configured to transmit the record to a claim management system.

### FIELD

Embodiments relate to systems and methods to facilitate the assignment of an incoming insurance claim to an appropriate claim-handling entity.

### BACKGROUND

Businesses and individuals acquire insurance policies to ensure against various risks. An insurance policy is a contract between an entity (e.g., a business, an individual, or any legal entity) and an insurance company. According to a typical insurance policy, the entity agrees to pay periodic premiums and the insurance company agrees to pay a specified amount to the entity if a specified event occurs. If the event occurs, the entity submits an insurance claim in order to collect the amount.

The insurance claim is evaluated and, if required under the terms of the insurance policy, the amount is paid to the entity. An insurance claim may be received and evaluated by the insurance company (i.e., using an internal claim-handling department) or by a third-party administrator hired by the insurance company to provide these functions. An insurance company may provide claim handling functions for certain insurance policies, and may hire a third-party administrator to handle claims associated with other insurance policies. In some instances, a third-party administrator owned by the insurance company provides claim-handling functions for insurance policies issued by the insurance company and/or for insurance policies issued by one or more other insurance companies.

To better manage costs, the insurance company may pay a periodic fixed fee to the third-party administrator for claim handling. Under such an arrangement, the third-party administrator receives and evaluates claims and pays any amounts due, and receives no further payment (e.g., reimbursement) from the insurance company.

Conventional claim intake systems assign received claims to claim-handling organizations based on physical lists and/or hardcoded associations (e.g., a data record associating a particular insurance policy with a particular third-party administrator). These mechanisms have proven to be unsatisfactory, at least in part because the associations between insurance policies and claim-handling organizations may be fluid (i.e., the responsibility for handling claims associated with a particular policy may change over time). For example, conventional systems may incorrectly assign a claim that should be handled by a third-party administrator to a claim-handling arm of the insurance company. The insurance company may then expend resources to handle the claim and to pay any amount owed, even though the insurance company has already paid the third-party administrator to perform these functions.

### SUMMARY

Some embodiments provide efficient assignment of claims to appropriate claim-handling organizations.

For example, a computer system is described which includes a data storage device configured to receive and store policy information associated with an insurance policy, and configured to receive and store a first data structure associating each of a plurality of program identifiers with a respective claim handling identifier. A computer processor is to execute program instructions and to retrieve the policy information from the data storage device, and a memory, coupled to the computer processor, is to store program instructions for execution by the computer processor.

Also included is claim assignment logic comprising program instructions stored in the memory and executable by the computer processor to determine a program identifier based on the policy information and to determine a first claim handling identifier associated with the program identifier in the first data structure. If the first claim handling identifier is a first predetermined claim handling identifier, a record associating the policy information with the first claim handling identifier is generated. If the first claim handling identifier is a second predetermined claim handling identifier, a second claim handling identifier is determined based on the policy information, and a record associating the policy information with the second claim handling identifier is generated. A communication device is to transmit the record to a claim management system.

In some aspects, the second claim identifier is determined if the first claim handling identifier of the record is associated with third party administrator claim handling. An extract identifier is determined based on the program identifier and on a second data structure associating each of a plurality of program identifiers with a respective extract handling identifier and third party administrator information. A subset of the policy information is determined based on the extract identifier, and it is determined that the subset of the policy information matches corresponding third party administrator information associated with the program identifier in the third data structure, wherein the second claim handling identifier is associated with third party administrator claim handling.

Some aspects include determination of a policy inception date based on the policy information, and identification of a record of a second data structure associated with the program identifier and with a time period including the policy inception date, wherein the second claim handling identifier is associated with the record and is associated with claim handling by an insurance company associated with the insurance policy.

According to additional aspects, a claim associated with the policy is received from a claimant, the claim handling identifier of the record associated with the policy is identified, and the claim is processed based on the claim handling identifier of the record associated with the policy. If the claim handling identifier of the record associated with the policy is associated with third party administrator claim handling, processing the claim may include identification of third party administrator contact information of the record associated with the policy and provision of the third party administrator contact information to the claimant. If the claim handling identifier of the record associated with the policy is associated with claim handling by an insurance company associated with the insurance policy, processing the claim may include assignment of the claim to a claim office of the insurance company.

With these and other advantages and features that will become apparent, embodiments may be more clearly understood by reference to the following detailed description, the appended claims, and the drawings attached hereto.

### BRIEF DESCRIPTION OF THE DRAWINGS

FIG. 1 illustrates a system architecture within which some embodiments may be implemented.

FIG. 2 is a partial functional block diagram of a computer system to associate claim handling identifiers with insurance policies in accordance with some embodiments.

FIGS. 3 through 6 illustrate a flow diagram of a process according to some embodiments.

FIG. 7 is a tabular representation of a portion of a data structure according to some embodiments.

FIG. 8 is a tabular representation of a portion of a data structure according to some embodiments.

FIG. 9 is a tabular representation of a portion of a data structure according to some embodiments.

FIG. 10 is a tabular representation of a portion of a data structure according to some embodiments.

FIG. 11 is a partial functional block diagram of a computer system to provide claim management in accordance with some embodiments.

FIG. 12 illustrates a flow diagram of claim processing according to some embodiments.

FIG. 13 is a partial functional block diagram of a computer system to facilitate claim processing in accordance with some embodiments.

FIG. 14 is an outward view of an interface of a claim management client application according to some embodiments.

FIG. 15 is an outward view of an interface of a claim management client application according to some embodiments.

### DETAILED DESCRIPTION

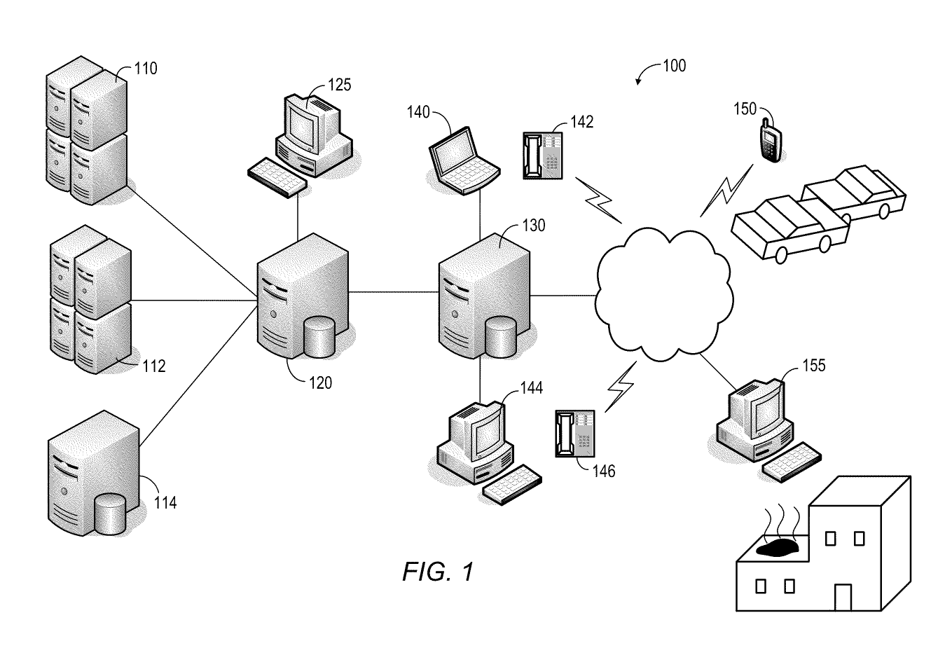

FIG. 1 illustrates system architecture 100 within which some embodiments may be implemented. Although some devices of architecture 100 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

According to the example of FIG. 1, policy sources 110 through 114 store policy information associated with insurance policies. Policy information may include any combination of policy-related data fields that are or become known, including but not limited to policy type, policy number, insured name, deductibles, coverage limits, riders and exceptions. Each of policy sources 110 through 114 may comprise any combination of hardware and/or software, including but not limited to relational databases, application servers, and spreadsheets. One or more of policy sources 110 through 114 may comprise a policy issuing system, a data warehouse of an insurance company or any other aggregator of insurance policy information.

Each of policy sources 110 through 114 may provide policy information to system 120 asynchronously or according to any schedule. In some embodiments, one or more of policy sources 110 through 114 provides a daily feed of policy information to system 120. The policy information of the feed may be associated with new insurance policies for which an initial premium has been paid.

System 120 may comprise any combination of hardware and software to perform processes as described herein. According to some embodiments, system 120 receives policy information associated with an insurance policy from one of sources 110 through 114, determines a program identifier based on the policy information, and determines a first claim handling identifier based on the program identifier and on a first data structure associating each of a plurality of program identifiers with a respective claim handling identifier. System 120 then transmits, to claim management system 130, a record associating the policy information with a second claim handling identifier. Details of the foregoing process and additional processes are provided below.

As will be described below, system 120 may comprise a plurality of data structures, such as relational database tables. System 120 may also comprise program instructions of a database management system, database procedures and/or database applications to process the data stored in the data structures. Terminal 125 may be operated to edit this data and to otherwise provide commands to system 120. For example, terminal 125 may be operated to update a data structure including information associated with a third-party administrator. Such an update may change the telephone number associated with the third-party administrator, the date on which the third-party administrator is to begin handling certain claims, or the like. Terminal 125 may comprise any suitable device, including but not limited to a desktop computer.

Claim management system 130 may receive policy records and associated claim handling identifiers from system 120. Claim management system 130 may receive a report of a claim associated with an insurance policy and determine the claim handling identifier of the record associated with the insurance policy. A customer service representative may use the claim handling identifier to assign the claim to the appropriate claim-handling organization. In this regard, customer service representatives may operate terminals 140 and 144 to access the records of claim management system 130. All terminals described herein may comprise any suitable devices for requesting and displaying user interfaces, including but not limited to desktop computers, cellular telephones, personal digital assistants, and laptops.

According to some examples, an insured entity (i.e., an individual) is involved in an automobile accident as depicted in FIG. 1. Also depicted in FIG. 1 is a loss related to a structure fire. Embodiments are not limited to these losses or to insurance policies for insuring against these types of losses. The individual involved in the automobile accident operates telephone 150 to cell a claim-reporting telephone number provided by an insurance company. The call is passed through network 160 (e.g., the Public Switched Telephone Network, a cellular network, and/or an Internet Protocol network) and terminates at telephone 146 of a customer service representative. Embodiments may also or alternatively provide claim reporting via one or more other communication modes, such as facsimile, electronic mail, or World Wide Web.

The customer service representative receives an identifier of the insured's policy (e.g., policy number, social security number, etc.) and operates a client application executed by terminal 144 to retrieve a record of claim management system 130 associated with the policy. The customer service representative determines a claim handling identifier of the record and assigns the claim based thereon. Depending on the nature of the claim handling identifier, assignment of the claim may include providing a telephone number of a third-party administrator to the insured or transferring the telephone call to a claim-handling organization of the insurance company.

It should be noted that embodiments are not limited to the devices illustrated in FIG. 1. Each device may include any number of disparate hardware and/or software elements, some of which may be located remotely from one another. Functions attributed to one device may be performed by one or more other devices in some embodiments. The devices of system 100 may communicate with one another (and with other non-illustrated elements) over any suitable communication media and protocols that are or become known.

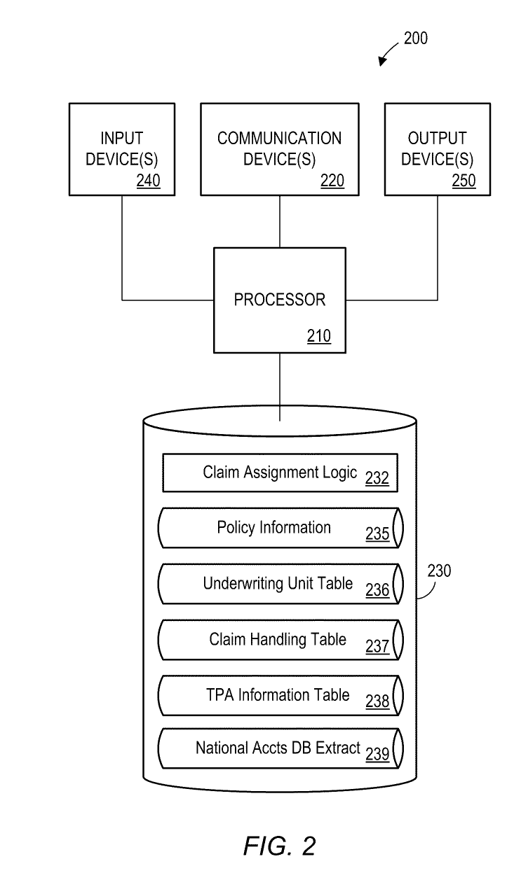

FIG. 2 is a block diagram of computer system 200. Computer system 200 may represent an implementation of system 120 according to some embodiments. Computer system 200 includes computer processor 210 operatively coupled to one or more communication devices 220, data storage device 230, one or more input devices 240 and one or more output devices 250. Communication device(s) 220 may facilitate communication with one or more networks and/or external devices. Input device(s) 240 may comprise, for example, a keyboard, a keypad, a mouse or other pointing device, a microphone, knob or a switch, an infra-red (IR) port, a docking station, and/or a touch screen. Input device(s) 240 may be used, for example, to enter information into computer system 200. Output device(s) 250 may comprise, for example, a display (e.g., a display screen) a speaker, and/or a printer.

Data storage device 230 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

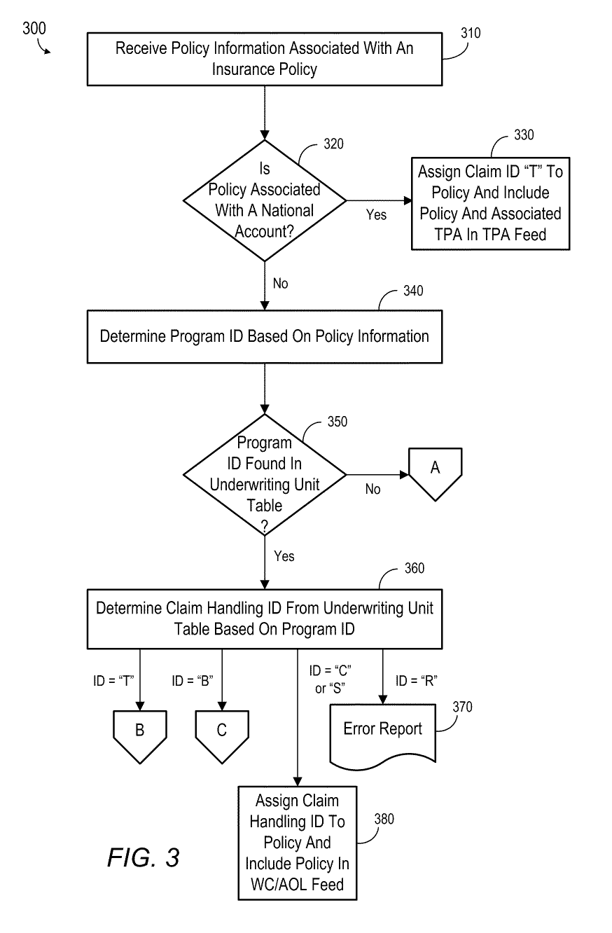

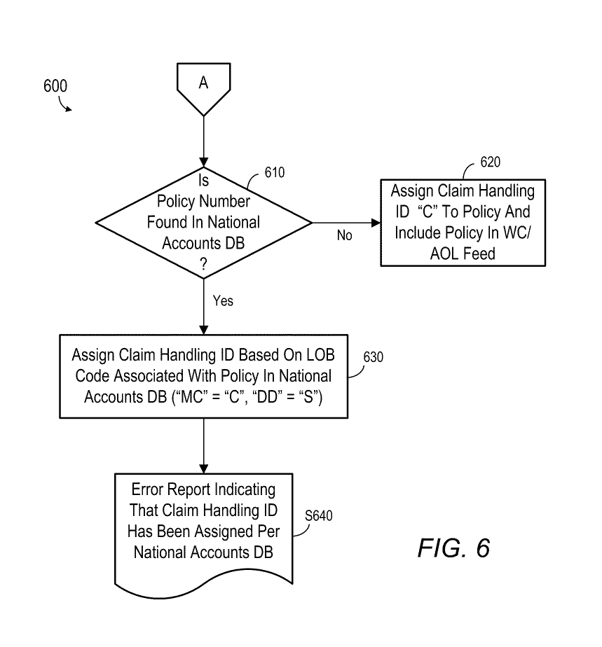

Data storage device 230 stores program instructions for execution by processor 210. Claim assignment logic 232 may comprise a set of such instructions, and may be executed by processor 210 to cause system 200 to operate as described herein with respect to FIGS. 3 through 6. Claim assignment logic 232 may comprise any executable instructions, including but not limited to a database procedure, a database application, a server application and a desktop application.

Data storage device 230 stores data structures used during execution of claim assignment logic 232 according to some embodiments. These data structures will be described below as relational tables, but embodiments are not limited thereto. Moreover, the data structures need not be physically separated in memory as depicted herein.

Policy information 235 comprises information received from data sources 110 through 114 as described above. Policy information 235 may include, for a single insurance policy, information received from more than one source, including information entered directly to system 200 via a terminal such as terminal 125.

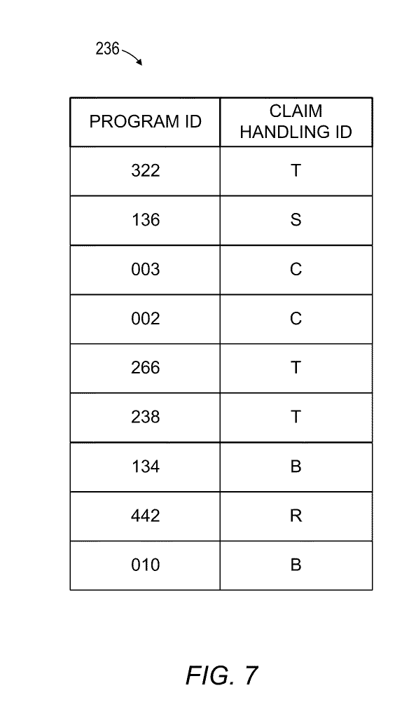

According to some embodiments, underwriting unit table 236 includes records associating program identifiers with claim handling identifiers. According to some embodiments, a “program” refers to a particular group of insurance policies. The policies within a program may be grouped together based on any suitable reason, such as their respective risks, their common association with a large account, etc. The policy number of each insurance policy within a program includes a program identifier which identifies the program. For example, the first three digits of a policy number may be reserved for the program identifier, but embodiments are not limited thereto. An example of a portion of underwriting unit table 236 is shown in FIG. 7 and usage thereof will be described in conjunction with FIG. 3.

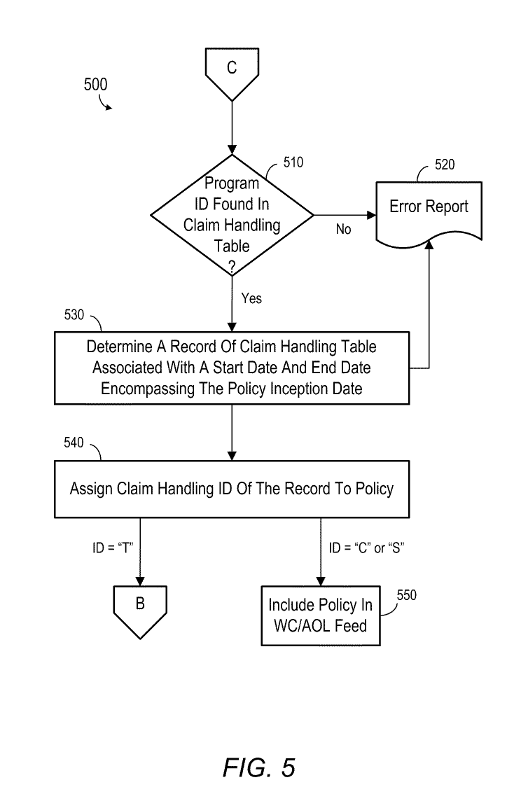

Claim handling table 237 includes, in some embodiments, records associating program identifiers with claim handling identifiers, start dates and end dates. Claim handling table 237 may address existing issues with changing claim handling requirements. Usage of claim handling table 237 according to some embodiments is described below with respect to FIG. 5.

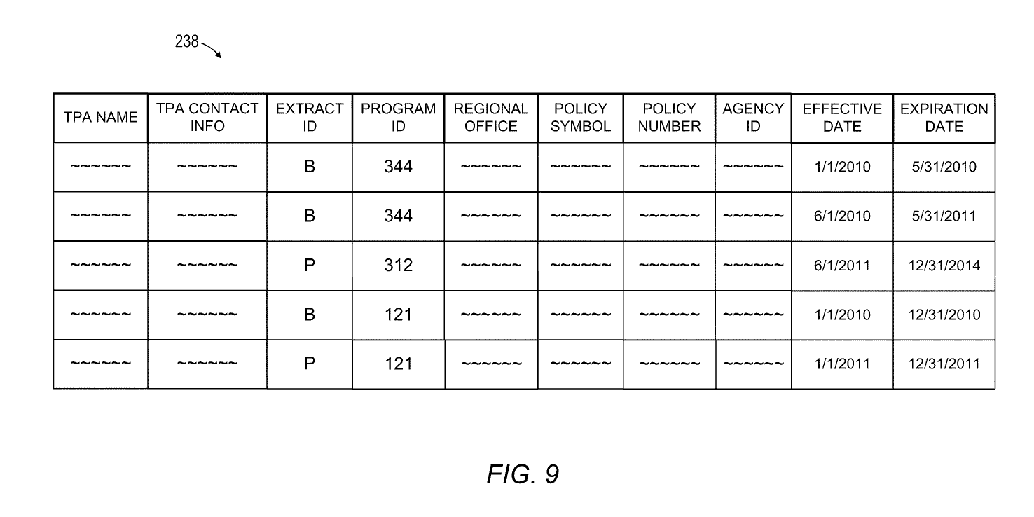

Third-party administrator information table 238 may include records associating third-party administrator contact information with policy information and an effective time period. Accordingly, each record may indicate a particular third-party administrator for handling claims which arise under a particular insurance policy within the particular time period. An example of a portion of third-party administrator information table 238 according to some embodiments shown in FIG. 9.

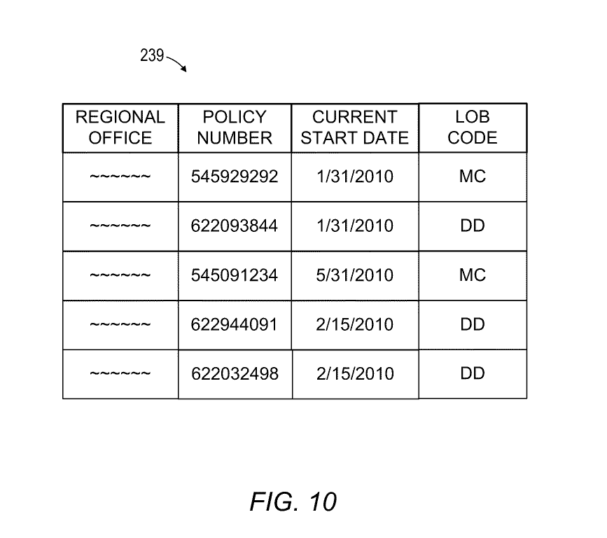

According to some embodiments, national accounts database extract 239 includes data related to national accounts. FIG. 10 illustrates an example of national accounts database extract 239. As evident from its name, the data of national accounts database extract 239 is a subset of data stored in a national accounts database. A national account may represent many insurance policies associated with a same insured entity (e.g., a national retailer, a national restaurant chain). Claims associated with these policies are often handled by dedicated representatives. Therefore, claim assignment logic 232 uses the data of national accounts database extract 239 to identify these policies and properly assign such claims.

The tables stored in data storage device may be updated via a network connection and/or via an attached terminal 125. Advantageously, the tables may provide a single repository for such data and claim assignment logic may properly assign claims regardless of any changes to the data.

Computer system 200 may include unshown elements for providing additional functionality and/or which are necessary for operation thereof, such as device drivers, operating system files, etc.

FIG. 3 is a flow diagram of process 300 according to some embodiments. Various elements of system 120 and/or computer system 200 may execute process 300 according to some embodiments. Process 300 may be embodied within program instructions of claim assignment logic 232, but embodiments are not limited thereto.

Process 300 and all other processes mentioned herein may be embodied in processor-executable program instructions read from one or more computer-readable media, such as a floppy disk, a CD-ROM, a DVD-ROM, a Zip™ disk, and a magnetic tape, and then stored in a compressed, uncompiled and/or encrypted format. In some embodiments, hard-wired circuitry may be used in place of, or in combination with, program instructions for implementation of processes according to some embodiments. Embodiments are therefore not limited to any specific combination of hardware and software.

Initially, at step 310, policy information associated with an insurance policy is received. According to the present example, a new record of policy information 235 is created and populated with the received policy information. As described above, the policy information may be received from one or more of policy sources 110 through 114 asynchronously or according to any schedule. The received policy information may be associated with a new insurance policy for which an initial premium has been paid.

Policy information may include any combination of policy-related data fields that are or become known, including but not limited to policy type, policy number, insured name, deductibles, coverage limits, riders and exceptions. Although the processes of FIGS. 3 through 6 will be described with respect to policy information of a single insurance policy, policy information associated with more than one insurance policy may be received at step 310, and the processes of FIGS. 3 through 6 may be applied separately to the policy information of each insurance policy.

At step 320, it is determined whether the insurance policy is associated with a national account. The determination at step 320 may include determining whether a record of third-party administrator information table 238 includes the full “policy string” (i.e., Regional Office, Policy Symbol and Policy Number) of the policy information. If so, the third-party administrator information associated with the record (e.g., name, contact information) is determined and, at step 330, the determined third-party administrator information and the claim handling identifier “T” are added to the corresponding record of policy information 235.

The corresponding record is then added to a “third-party administrator feed”. The third-party administrator feed may include one or more records and may be transmitted to claim management system 130 according to any desired schedule.

If it is determined that the insurance policy is not associated with a national account, a program identifier is determined from the received policy information. According to some embodiments, the program identifier is represented by the first three digits of the policy number. At step 350, it is determined whether the program identifier is present in underwriting unit table 236. As mentioned above, underwriting unit table 236 includes records associating program identifiers with claim handling identifiers.

Assuming that the program identifier is present in underwriting unit table 236, a claim handling identifier associated with the program identifier is determined from the underwriting unit table 236 at step 360. With respect to the example of FIG. 7, the claim handling identifier “S” is determined at step 360 if the determined program identifier is “136”. Continuing with this example, the claim handling identifier “S” is then assigned to the insurance policy and the policy is added to a Workers' Compensation/All Other Lines feed at step 370. As illustrated in FIG. 3, step 370 is similarly executed in a case that the claim handling identifier determined at step 360 is “C”. The Workers' Compensation/All Other Lines feed may also include one or more records and may be transmitted to claim management system 130 according to any desired schedule.

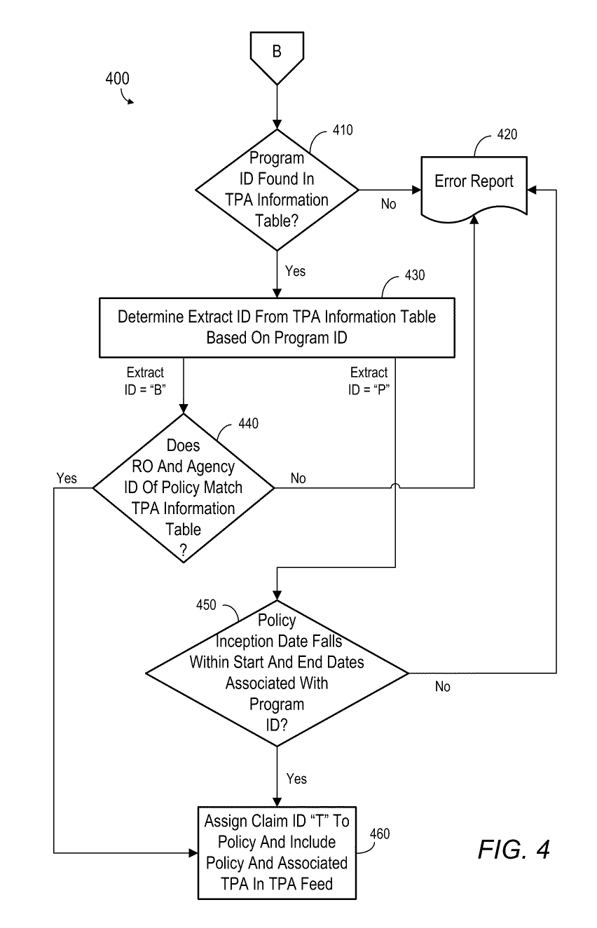

Flow proceeds to step 410 of FIG. 4 if the claim handling identifier “T” is determined at step 360. It is determined at step 410 whether the program identifier is present in third-party administrator information table 238. As shown in FIG. 9, third-party administrator information table 238 may include records associating third-party administrator contact information with a program identifier and an effective time period. If the program identifier is not present in third-party administrator information table 238, the record of policy information 235 including the received policy information is written to an error report at step 420. If the program identifier is present, an extract identifier is determined from third-party administrator information table 238 at step 430. More particularly, a record of third-party administrator information table 238 which includes the determined program identifier is located, and an extract identifier of the located record is determined.

Flow proceeds to step 440 if the determined extract identifier is “B”. At step 440, it is determined whether the Regional Office and the agency identifier of the located record (i.e., the record including the program identifier) match the Regional Office and the agency identifier of the received policy information. If not, the record including the policy information is written to an error report at step 420 as described above. If so, the third-party administrator information of the located record and the claim handling identifier “T” are added to the corresponding record of policy information 235, and the corresponding record is then added to the third-party administrator feed at step 460.

If the extract identifier determined at step 430 is “P”, it is then determined, at step 450, if the policy inception date of the policy information record falls within a start date and an end date associated with the program identifier in third-party administrator information table 238. This determination is intended to address situations in which claim-handling responsibilities for the policy are transferred from one third-party administrator to another. If the determination at step 450 is affirmative, flow continues to step 460 and operates as described above. If negative, flow returns to step 420 to create an error report.

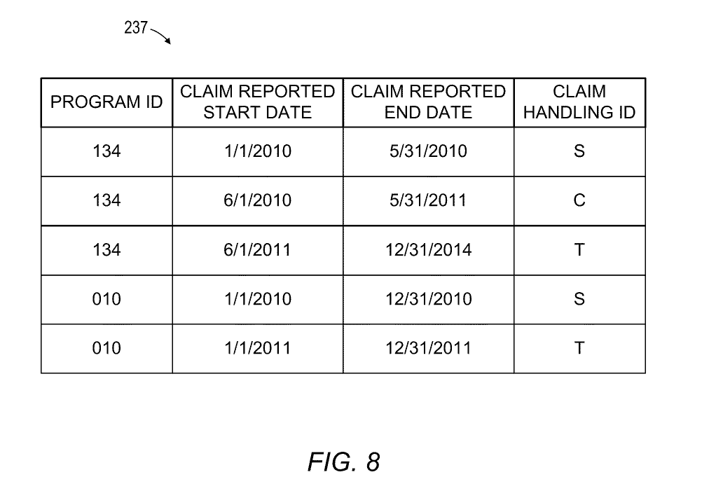

Returning to FIG. 7, the claim handling identifier determined at step 360 may be “B” in some examples. Flow therefore continues to step 510 of FIG. 5 to determine whether the program identifier is found in claim handling table 237. FIG. 8 illustrates an example of a portion of table 237 according to some embodiments.

An error report is generated at step 520 if the program identifier is not found in claim handling table 237. Flow proceeds to step 530 if the program identifier is found. At step 530, a record of table 237 is determined which includes the program identifier as well as a start date and an end date which encompass the policy inception date. In this regard, table 237 may include multiple records associated with a same program identifier.

The claim handling identifier of the record determined at step 530 is assigned to the policy at step 540. This assignment may include, as described above, adding the claim handling identifier to the record of policy information 235 which is associated with the received policy information. If the claim handling identifier is “T”, flow returns to step 410 and continues therefrom as described above. If the claim handling identifier is “C” or “S”, the current record of policy information 235 is added to the Workers' Compensation/All Other Lines feed at step 550.

A claim handling identifier of “R” may be determined at step 360 according to some examples. In response to such a determination, the policy information is written to an error report at step 380. “R” may be used to denote a program identifier that is reserved for future use.

Returning to step 350, flow continues therefrom to step 610 if the program identifier is not found in underwriting unit table 236. National accounts database extract 239 is searched at step 610 for the policy number of the policy information received at step 310. FIG. 10 illustrates a portion of database extract 239 for purposes of example. If the policy number is not found, a claim handling identifier of “C” is included in the current record of policy information 235 and the record is added to the Workers' Compensation/All Other Lines feed at step 620.

If the policy number is found in national accounts database extract 239, a claim handling identifier is assigned to the current record of policy information 235 at step 630 based on the Line of Business code associated with the policy number in national accounts database extract 239. For example, and with reference to FIG. 10, the Line of Business code “MC” is determined for the policy number “545929292”. According to some embodiments, the claim handling identifier “C” is therefore assigned to the current record. For policy numbers associated with the Line of Business code “DD”, the claim handling identifier “S” is therefore assigned to the current record.

Next, at step 640, an error report is generated indicating that the claim handling identifier has been assigned to the record based on the national accounts database.

For each record transmitted to claim management system 130, claim management system 130 may return an electronic and/or tangible receipt to system 120. The receipt may allow system 120 to verify that the claim-handling information was provided for each processed insurance policy.

Some embodiments employ predictive modeling to enhance the above-described processing. For example, a predictive model may be trained with historical policy information and associated claim handling identifiers, and applied to received policy information to determine an appropriate claim handling identifier. The predictive model may identify “predictive characteristics” of the policy information (e.g., liability limits, Zip code, etc.) which exhibit a significant correlation with an eventually-assigned claim handling identifier. Accordingly, the predictive characteristics of the received policy information may be analyzed by the predictive model to determine a claim handling identifier. This determination may be used to verify the suitability of a claim handling identifier determined using the process of FIGS. 3 through 6, or as a substitute for this determination.

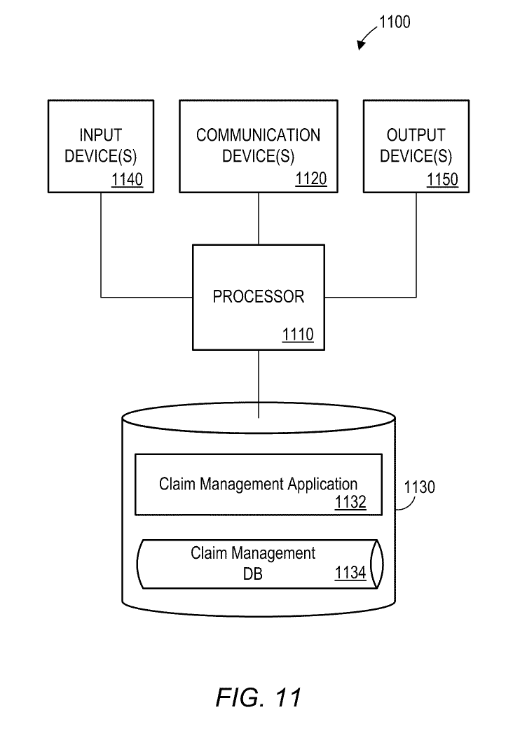

FIG. 11 is a block diagram of computer system 1100 according to some embodiments. Computer system 1100 may perform the functions attributed above to Claim management system 130. The elements of computer system 1100 may be implemented using any of the alternatives described above with respect to similarly-named and numbered elements of computer system 200, but embodiments are not limited thereto.

Computer system 1100 may receive records of the various feeds generated according to the process of FIGS. 3 through 6. The records may be received via one or more of communication device(s) 1120 and each record represents an insurance policy associated with policy information and a claim handling identifier. The records are stored in claim management database 1134 of data storage device 1130. Claim management database 1134 may include records associated with insured entities and may associate a record of an insured entity with each record of each insurance policy associated with the insured entity. Claim management application 1132 includes executable program instructions to provide claim management functions based on the records of database 1134.

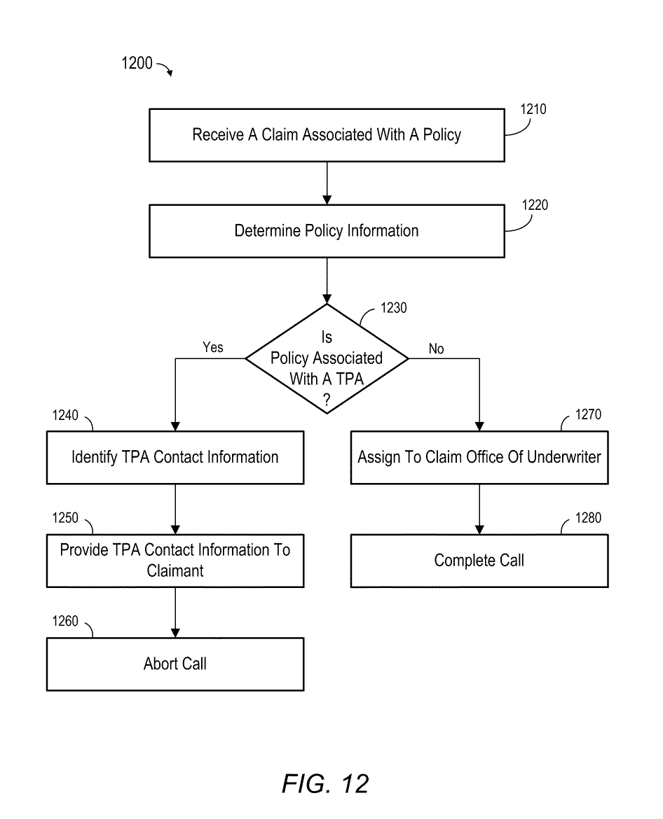

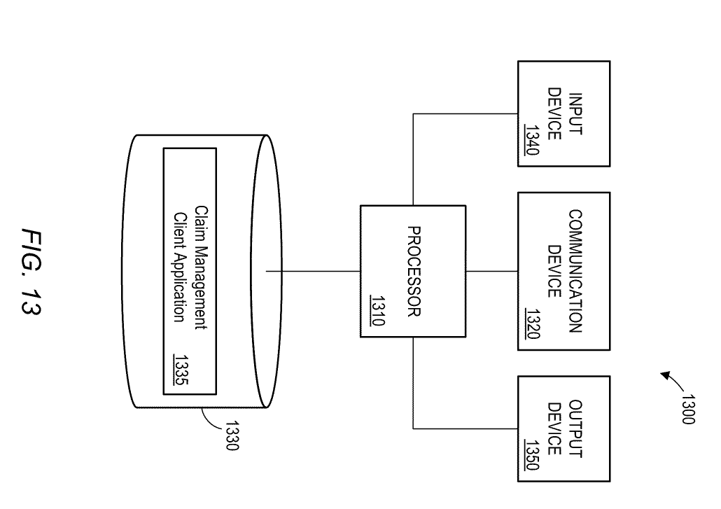

Process 1200 of FIG. 12 may be executed to assign a claim according to some embodiments. Process 1200 may be executed by a terminal such as terminals 140 or 142 of FIG. 1. FIG. 13 is a block diagram of terminal 1300 to execute process 1200 according to some embodiments. Claim management client application 1335 may comprise a proprietary application for interfacing with claim management application 1132 of system 1100, and/or a Web browser to receive and display Web pages provided by a Web server of claim management application 1132. In this regard, either or both of computer systems 1100 and 1300 may be considered as performing process 1200 in some embodiments.

Process 1200 begins at step 1210, in which a report of a claim is received. The claim is associated with an insurance policy. As mentioned with respect to FIG. 1, a report of a claim may be received at step 1210 via a telephone call (e.g., phone 150), a computer (e.g., terminal 155) or any other means. A customer service representative operates claim management client application 1335 to determine policy information at step 1220.

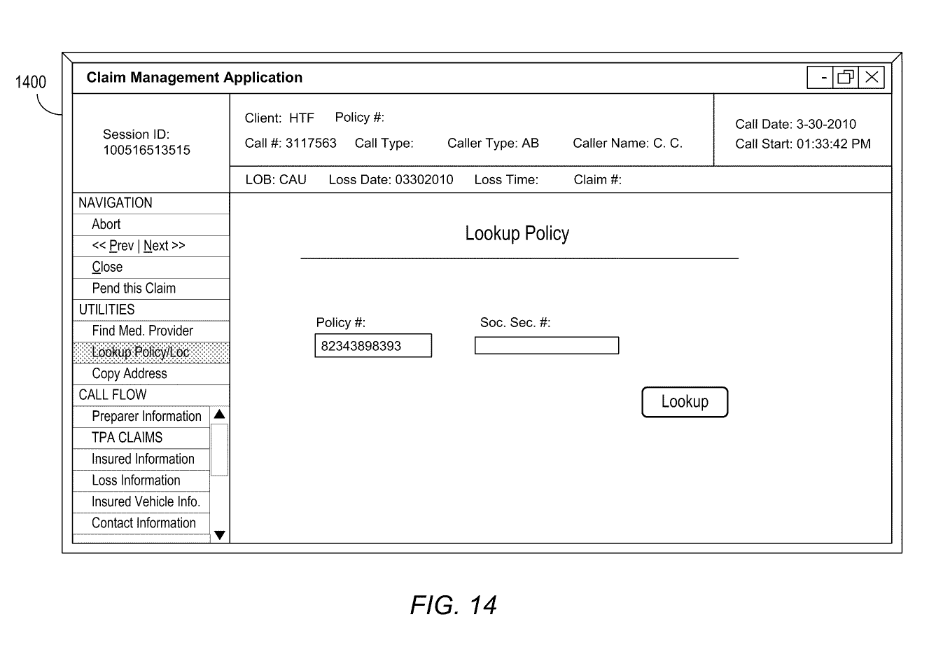

FIG. 14 is an outward view of interface 1400 presented by output device 1350 according to some embodiments. The representative inputs information into one or both fields of interface 1400 in order to identify the policy at step 1220. Next, at step 1230, it is determined whether the policy is associated with a third-party administrator.

According to some embodiments, step 1220 includes identification of a record of claim management database 1134 which is associated with the entered policy information. The record includes a claim handling identifier as described above. Accordingly, the determination at step 1230 is affirmative if the claim handling identifier of the record is “T”.

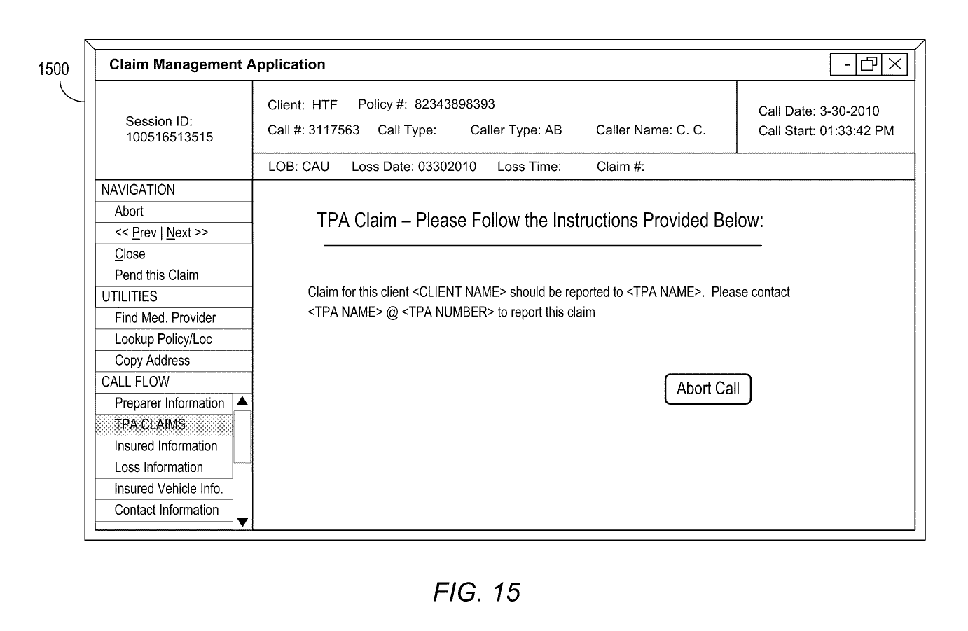

If so, contact information of the third-party administrator is determined from the record at step 1240 and the contact information is displayed to the representative as shown in FIG. 15. This information is provided to the claimant (orally and/or electronically) at step 1250 and the call is aborted at step 1260. If the claim handling identifier of the record is not “T”, the claim is assigned to a claim department of the insurance company at step 1270 and the call is completed at step 1280. Completion of the call at step 1280 may comprise capturing data elements that will be subsequently used by the claim department to process the claim.

The embodiments described herein are solely for the purpose of illustration. Those in the art will recognize that other embodiments may be practiced with modifications and alterations limited only by the claims.

What is claimed is:

1. A computer system comprising:
a data storage device configured to receive and store policy information associated with an insurance policy, and a first data structure associating each of a plurality of program identifiers with a respective claim handling identifier;
a computer processor configured to execute program instructions and to retrieve the policy information from the data storage device;
a memory, coupled to the computer processor, configured to store program instructions for execution by the computer processor;
claim assignment logic comprising program instructions stored in the memory and executable by the computer processor to:
determine a program identifier based on the policy information;
determine a first claim handling identifier associated with the program identifier in the first data structure;
generate, if the first claim handling identifier comprises a first predetermined claim handling identifier, a record associating the policy information with the first claim handling identifier; and
if the first claim handling identifier comprises a second predetermined claim handling identifier, determine a second claim handling identifier based on the policy information and generate a record associating the policy information with the second claim handling identifier; and
a communication device, coupled to the computer processor, configured to transmit the record to a claim management system.

2. A computer system according to claim 1, wherein the program instructions stored in the memory and executable by the computer processor to determine the second claim handling identifier comprise program instructions stored in the memory and executable by the computer processor to:
determine a policy inception date based on the policy information;
identify a record of a second data structure associated with the program identifier and with a time period including the policy inception date;
determine that a claim handling identifier of the record of the second data structure is associated with third party administrator claim handling;
determine an extract identifier based on the program identifier and on a third data structure associating each of a plurality of program identifiers with a respective extract identifier and third party administrator information;
determine a subset of the policy information based on the extract identifier; and
determine that the subset of the policy information matches corresponding third party administrator information associated with the program identifier in the third data structure,
wherein the second claim handling identifier is associated with third party administrator claim handling.

3. A computer system according to claim 2, wherein the subset of the policy information comprises a regional office and an agency identifier.

4. A computer system according to claim 2, wherein the subset of the policy information comprises the policy inception date, and wherein the corresponding third party administrator information comprises a start date and an end date.

5. A computer system according to claim 1, wherein the first claim handling identifier of the record is associated with third party administrator claim handling, and wherein the program instructions stored in the memory and executable by the computer processor to determine the second claim handling identifier comprise program instructions stored in the memory and executable by the computer processor to:
determine an extract identifier based on the program identifier and on a second data structure associating each of a plurality of program identifiers with a respective extract handling identifier and third party administrator information;
determine a subset of the policy information based on the extract identifier; and
determine that the subset of the policy information matches corresponding third party administrator information associated with the program identifier in the third data structure,
wherein the second claim handling identifier is associated with third party administrator claim handling.

6. A computer system according to claim 5, wherein the subset of the policy information comprises a regional office and an agency identifier.

7. A computer system according to claim 5, wherein the subset of the policy information comprises the policy inception date, and wherein the corresponding third party administrator information comprises a start date and an end date.

8. A computer system according to claim 1, wherein the program instructions stored in the memory and executable by the computer processor to determine the second claim handling identifier comprise program instructions stored in the memory and executable by the computer processor to:
determine a policy inception date based on the policy information; and
identify a record of a second data structure associated with the program identifier and with a time period including the policy inception date,
wherein the second claim handling identifier is associated with the record and is associated with claim handling by an insurance company associated with the insurance policy.

9. A computer system according to claim 1, further comprising the claim management system, the claim management system comprising:
a second data storage device for receiving and storing the record associating the policy information with the second claim handling identifier;
a second computer processor for executing program instructions;
a second memory, coupled to the second computer processor, for storing program instructions for execution by the second computer processor; and
claim management logic further comprising program instructions stored in the memory and executable by the computer processor to:
receive a claim associated with the policy from a claimant;
identify the claim handling identifier of the record associated with the policy; and
process the claim based on the claim handling identifier.

10. A computer system according to claim 1, wherein,
if the claim handling identifier of the record associated with the policy is associated with third party administrator claim handling, processing the claim comprises identification of third party administrator contact information of the record associated with the policy and provision of the third party administrator contact information to the claimant, and
if the claim handling identifier of the record associated with the policy is associated with claim handling by an insurance company associated with the insurance policy, processing the claim comprises assignment of the claim to a claim office of the insurance company.

11. A computer system according to claim 1, wherein the program instructions stored in the memory are further executable by the computer processor to:
determine a predicted claim handling identifier based on a predictive model and on the policy information; and
compare the predicted claim handling identifier to the claim handling identifier associated with the record.

12. A computer-implemented method comprising:
receiving policy information associated with an insurance policy;
determining a program identifier based on the policy information;
determining a first claim handling identifier based on the program identifier and on a first data structure associating each of a plurality of program identifiers with a respective claim handling identifier;
if the first claim handling identifier comprises a first predetermined claim handling identifier, generating a record associating the policy information with the first claim handling identifier;
if the first claim handling identifier comprises a second predetermined claim handling identifier, determining a second claim handling identifier based on the policy information and generating a record associating the policy information with the second claim handling identifier; and transmitting the record to a claim management system.

13. A computer-implemented method according to claim 12, wherein determining the second claim handling identifier comprises
determining a policy inception date based on the policy information;
identifying a record of a second data structure associated with the program identifier and with a time period including the policy inception date;
determining that a claim handling identifier of the record is associated with third party administrator claim handling;
determining an extract identifier based on the program identifier and on a third data structure associating each of a plurality of program identifiers with a respective extract handling identifier and third party administrator information;
determining a subset of the policy information based on the extract identifier; and
determining that the subset of the policy information matches corresponding third party administrator information associated with the program identifier in the third data structure,
wherein the second claim handling identifier is associated with third party administrator claim handling.

14. A computer-implemented method according to claim 13, wherein the subset of the policy information comprises a regional office and an agency identifier.

15. A computer-implemented method according to claim 13, wherein the subset of the policy information comprises the policy inception date, and wherein the corresponding third party administrator information comprises a start date and an end date.

16. A computer-implemented method according to claim 12, wherein the first claim handling identifier of the record is associated with third party administrator claim handling, and wherein determining the second claim handling identifier comprises:
determining an extract identifier based on the program identifier and on a second data structure associating each of a plurality of program identifiers with a respective extract handling identifier and third party administrator information;
determining a subset of the policy information based on the extract identifier; and
determining that the subset of the policy information matches corresponding third party administrator information associated with the program identifier in the third data structure,
wherein the second claim handling identifier is associated with third party administrator claim handling.

17. A computer-implemented method according to claim 16, wherein the subset of the policy information comprises a regional office and an agency identifier.

18. A computer-implemented method according to claim 16, wherein the subset of the policy information comprises the policy inception date, and wherein the corresponding third party administrator information comprises a start date and an end date.

19. A computer-implemented method according to claim 12, further comprising:
determining a policy inception date based on the policy information; and
identifying a record of a second data structure associated with the program identifier and with a time period including the policy inception date,
wherein the claim handling identifier associated with the record is associated with claim handling by an insurance company associated with the insurance policy.

20. A computer-implemented method according to claim 12, further comprising:
receiving a claim associated with the policy from a claimant;
identifying the claim handling identifier of the record associated with the policy; and
processing the claim based on the claim handling identifier.

21. A computer-implemented method according to claim 12, wherein,
if the claim handling identifier of the record associated with the policy is associated with third party administrator claim handling, processing the claim comprises identifying third party administrator contact information of the record associated with the policy and providing the third party administrator contact information to the claimant, and
if the claim handling identifier of the record associated with the policy is associated with claim handling by an insurance company associated with the insurance policy, processing the claim comprises assigning the claim to a claim office of the insurance company.

22. A computer-implemented method according to claim 12, further comprising:
determining a predicted claim handling identifier based on a predictive model and on the policy information; and
comparing the predicted claim handling identifier to the claim handling identifier associated with the record.

23. A system comprising:
a first system comprising:
a data storage device configured to receive and store policy information associated with an insurance policy, and a first data structure associating each of a plurality of program identifiers with a respective claim handling identifier;
a computer processor configured to execute program instructions and to retrieve the policy information from the data storage device;
a memory, coupled to the computer processor, configured to store program instructions for execution by the computer processor;
claim assignment logic comprising program instructions stored in the memory and executable by the computer processor to:
determine a program identifier based on the policy information;
determine a first claim handling identifier associated with the program identifier in the first data structure;
generate, if the first claim handling identifier comprises a first predetermined claim handling identifier, a record associating the policy information with the first claim handling identifier; and
if the first claim handling identifier comprises a second predetermined claim handling identifier, determine a second claim handling identifier based on the policy information and generate a record associating the policy information with the second claim handling identifier; and
a communication device, coupled to the computer processor, configured to transmit the record to a claim management system; and
the claim management system comprising:
a second data storage device for receiving and storing the record associating the policy information with the second claim handling identifier;
a second computer processor for executing program instructions;
a second memory, coupled to the second computer processor, for storing program instructions for execution by the second computer processor; and
claim management logic further comprising program instructions stored in the memory and executable by the computer processor to:
receive a claim associated with the policy from a claimant;
identify the claim handling identifier of the record associated with the policy; and
process the claim based on the identified claim handling identifier.
